(19) United States
(12) Patent Application Publication
(10) Pub. No.: US 2014/0149198 A1
(43) Pub. Date: May 29, 2014

(54) USER INTERFACE FOR MOBILE PAYMENT SERVICE

(71) Applicant: KT CORPORATION, Gyeonggi-do (KR)

(72) Inventors: Han-Na KIM, Seoul (KR); Chi-Young PARK, Seoul (KR)

(73) Assignee: KT CORPORATION, Gyeonggi-do (KR)

(21) Appl. No.: 14/093,213

(22) Filed: Nov. 29, 2013

(30) Foreign Application Priority Data
Nov. 28, 2012 (KR) 10-2012-0136503

(51) Int. Cl. G06Q 30/02; G06Q 20/32; G06Q 20/22

(52) U.S. Cl. CPC G06Q 30/0226; G06Q 20/227; G06Q 20/32
USPC 705/14.27

(57) ABSTRACT

The disclosure is related to a service for helping a consumer to intuitively identify, select, and combine payment instruments returning the relatively best membership to find a lowest payment amount for a desired purchase. User equipment may provide a graphic user interface that i) displays images of payment instruments classified by a payment instrument type, ii) scrollably displays images of the classified payment instruments, iii) displays an estimated lowest payment amount for a desired purchase by combining membership benefits of payment instruments based on payment instrument images scrolled and arranged at a selection position thereof.

### CROSS REFERENCE TO PRIOR APPLICATIONS

The present application claims priority under 35 U.S.C. §119 to Korean Patent Application No. 10-2012-0136503 (filed on Nov. 28, 2012), which is hereby incorporated by reference in its entirety.

The subject meter of this application is related to U.S. patent application Ser. No. 14/082,383 filed Nov. 18, 2013, as Attorney Docket No.: (801.0129), the teachings of which is incorporated herein in their entirety by reference.

### BACKGROUND

Lately, consumers are able to make payments through various types of payment means including payment instruments. The payment instrument is a card that might be used by a consumer and accepted by a merchant to make a payment for purchasing a good or a service. The payment instrument includes a credit card, a debit card, an automated teller machine (ATM), a charge card, a stored-value card, a gift card, and so forth.

Due to advanced technologies of mobile devices, consumers frequently want to make payments using a mobile payment service. The mobile payment service is also referred to as mobile money or a mobile wallet. The mobile payment service is a payment service that enables a consumer to make payment via a mobile device based on a predetermined financial agreement or regulation. Instead of making a payment with cash, a consumer can use a mobile device such as user equipment including a smart phone to pay for a wide range of services and goods. The mobile payment service might be a different application form of a payment instrument. For example, a payment instrument might be issued through a mobile device and digitally installed in the mobile device. Furthermore, many payment instrument companies (e.g., credit card companies) provide a digital version of a payment instrument that can be digitally installed in a mobile device and used as a mobile payment.

Due to various convenient features thereof, the mobile payment service has been popular among consumers. In general, the mobile payment service is provided to a consumer through a service application installed and executed in user equipment in connection with an associated service server. That is, such a mobile payment service is provided through a graphic user interface generated as a result of executing an associated service application and displayed on user equipment. Such a graphic user interface shows various types of information on a merchant, a desired purchase, and payment instruments. Based on the information in the graphic user interface, a user might select at least one payment instrument to make a payment for a desired purchase with a minimum cost.

### SUMMARY

This summary is provided to introduce a selection of concepts in a simplified form that is further described below in the Detailed Description. This summary is not intended to identify key features or essential features of the claimed subject matter, nor is it intended to be used to limit the scope of the claimed subject matter.

Embodiments of the present invention overcome the above disadvantages and other disadvantages not described above. Also, the present invention is not required to overcome the disadvantages described above, and an embodiment of the present invention may not overcome any of the problems described above.

In accordance with an aspect of the present embodiment, a consumer may be provided with a service for estimating the lowest payment amount for a desired purchase by combining payment instruments based on membership benefits thereof.

In accordance with another aspect of the present embodiment, a service may be provided through a service application installed and executed in user equipment for helping a consumer to select payment instruments returning the relatively best membership benefits and to estimate a payment amount for a desired purchase based on combination of the selected payment instruments through minimum user inputs.

In accordance with still another aspect of the present embodiment, user equipment may provide a graphic user interface that enables a user to intuitively identify payment instruments associated with a desired purchase, to conveniently select payment instruments returning the relatively best membership benefits among payment instruments associated with a desired purchase or a merchant thereof, and to easily combine the selected payment instruments to find the lowest payment amount for the desired purchase.

In accordance with yet still another aspect of the present invention, user equipment may provide a graphic user interface that i) displays images of payment instruments classified by a payment instrument type, ii) scrollably displays images of the classified payment instruments, iii) displays an estimated lowest payment amount for a desired purchase by combining membership benefits of payment instruments based on payment instrument images scrolled and arranged at a selection position thereof.

In accordance with at least one embodiment, a method may be provided for providing a graphic user interface through user equipment for a mobile payment service. The method may include receiving an input for initiating a service application for the mobile payment service, obtaining information on a desired purchase, an associated merchant, and information on associated payment instruments, as a result of executing the initiated service application and based on the obtained information, generating a graphic user interface to display i) a plurality of first display areas each assigned to each one of the payment instrument candidate groups, ii) information on payment instruments associated with a corresponding payment instrument candidate group in each first display area, iii) each first display area scrollable independently from other first display areas in response to a user input, iv) scrollable images of payment instruments in each first display area in response to a user input, v) each first display area having a selection position for selecting one of payment instruments of a corresponding payment instrument candidate group, and vi) a second display area including an estimated payment amount for the desired purchase, and displaying the generated graphic user interface through a display of the user equipment. The estimated payment amount of the desired purchase may be calculated by combining membership benefits of payment instruments arranged at the selection positions of the first display areas.

The method may further include detecting a scrolling input made by a user through the graphic user interface displayed on the display of the user equipment, scrolling the images of payment instruments arranged in the first display areas in response to the detected scrolling input, detecting payment instruments scrolled and arranged at the selection positions of the first display areas, recalculating the estimated payment amount for the desired purchase by combining membership benefits of the detected payment instruments, and displaying the recalculated payment amount in the second display area.

The obtaining may include obtaining information on the desired purchase and the associated merchant from a merchant system, collecting information on payment instruments associated with the desired purchase and the associated merchant, and classifying the associated payment instruments into payment instrument candidate groups by a payment instrument type.

The collecting information may include collecting information on payment instruments from at least one of a memory of the user equipment and an identification chip mounted in the user equipment.

The generating a graphic user interface may include generating the graphic user interface to display a default payment instrument to be arranged at the selection position of each first display area. The default payment instrument may be a payment instrument returning a relatively best membership benefit to a consumer among payment instruments in the same payment instrument candidate group.

The generating a graphic user interface may include generating the graphic user interface to display the second display area and more than two of first display areas at a single screen.

The generating a graphic user interface may include generating the graphic user interface to display the second display area to shows at least one of menus for selecting options and functions associated with the service application, interactive icons for receiving user inputs to initiate an associated operation, and information on the associated merchant, the desired purchase, and associated membership benefits.

The generating a graphic user interface may include generating the graphic user interface to display a first auto selection icon in the second display area. In response to a user input selecting the first auto selection icon, the first auto selection icon initiates operations for computing an optimal combination of payment instruments by selecting a relatively best payment instrument from each payment instrument candidate group and calculating an estimated payment amount of the desired purchase based on the computed optimal combination. Such computing an optimal combination may include selecting a relatively best payment instrument from each payment instrument candidate group, arranging and displaying the selected best payment instrument at the selection positions of first display areas, combining membership benefits of the selected payment instruments, calculating the estimated payment amount of the desired purchase based on the combined membership benefits, and displaying the calculated payment amount in the second display area. The computing an optimal combination may further include selecting one of the payment instrument candidate groups, selecting a second best payment instrument from the selected payment instrument candidate group, arranging and displaying the selected second best payment instrument at a selection position in a first display area associated with the selected payment instrument candidate group, combining a membership benefit of the selected second best payment instrument with membership benefits of payment instruments of other payment instrument candidate groups, arranged at selection positions in first display areas associated with the other payment instrument candidate groups, recalculating the estimated payment amount of the desired purchase based on the combined membership benefits, and displaying the recalculated payment among in the first display area.

The generating a graphic user interface may include generating the graphic user interface to display a second auto selection icon on one of images of payment instruments in the first display areas. In response to a user input selecting the second auto selection icon, the second auto selection icon may initiate operations for computing an optimal combination of a payment instrument associated with the second auto selection icon and other payment instruments in different payment instrument candidate groups. Such computing an optimal combination may include selecting a payment instrument associated with the second auto selection icon, selecting a relatively best payment instrument from a corresponding payment instrument candidate group different from a payment instrument candidate group associated with the second auto selection icon, arranging and displaying the selected best payment instruments at selection positions in first display areas associated with the payment instrument candidate groups, combining a membership benefit of the payment instrument associated with the second auto selection icon with membership benefits of the selected best payment instruments, recalculating the estimated payment amount of the desired purchase based on the combined membership benefits, and displaying the recalculated payment among in the first display area.

The generating a graphic user interface may include generating the graphic user interface to display an event info icon on one of images of payment instruments in the first display areas. In response to a user input selecting the event info icon, the event info icon may initiate operations for showing information on a promotion event associated with a payment instrument associated with the event info icon.

The generating a graphic user interface may include generating the graphic user interface to display a dummy payment instrument image included in at least one of the first display areas. In response to a user input for selecting and scrolling the dummy payment instrument image to a selection position, a payment instrument candidate group associated with the dummy payment instrument image may be excluded from computing the estimated payment amount and a payment process.

The generating a graphic user interface may include generating the graphic user interface to display an inactivated payment instrument image included in at least one of the first display areas. In response to a user input for selecting and scrolling the inactivated payment instrument image to a selection position, operations may be performed for issuance of an inactivated payment instrument associated with the inactivated payment instrument image.

The method may further include converting at least one of payment instruments arranged at the selection positions into predetermined code pattern images and displaying the predetermined code pattern images through the display of the user equipment.

In accordance with at least one embodiment, a non-transitory computer-readable storage medium storing a program may be performed for performing an operation on user equipment having a processor, the program which performs a method when executed by the processor. The method may include receiving an input for initiating a service application for the mobile payment service, obtaining information on a desired purchase, an associated merchant, and information on associated payment instruments, as a result of executing the initiated service application and based on the obtained information, generating a graphic user interface to display i) a plurality of first display areas each assigned to each one of the payment instrument candidate groups, ii) information on payment instruments associated with a corresponding payment instrument candidate group in each first display area, iii) each first display area scrollable independently from other first display areas in response to a user input, iv) scrollable images of payment instruments in each first display area in response to a user input, v) each first display area having a selection position for selecting one of payment instruments of a corresponding payment instrument candidate group, and vi) a second display area including an estimated payment amount for the desired purchase, calculating the estimated payment amount of the desired purchase by combining membership benefits of payment instruments arranged at the selection positions of the first display area, and displaying the generated graphic user interface through a display of the user equipment.

In accordance with at least one embodiment, a graphic user interface may be displayed on user equipment as a result of executing a service application for a mobile payment service. The graphic user interface may include a plurality of first display areas respectively assigned to different payment instrument candidate groups, each first display area displaying information on payment instruments associated with a corresponding payment instrument candidate group, each first display area scrollable independently from other first display areas in response to a user input, each first display area displaying scrollable images of payment instruments in response to a user input, each first display area having a selection position for selecting one of payment instruments of a corresponding payment instrument candidate group, and a second display area displaying an estimated payment amount for a desired purchase. The estimated payment amount of the desired purchase may be calculated by combining membership benefits of payment instruments arranged at the selection positions of the first display areas.

### BRIEF DESCRIPTION OF THE DRAWINGS

The above and/or other aspects of the present invention will become apparent and more readily appreciated from the following description of embodiments, taken in conjunction with the accompanying drawings, of which:

FIG. 1 illustrates user equipment in accordance with at least one embodiment of the present invention;

FIG. 2 illustrates a mobile payment service system in accordance with at least one embodiment of the present invention;

FIG. 3 illustrates a graphic user interface for enabling a user to intuitively identify, select, and combine payment instruments returning the relatively best membership to find a lowest payment amount for a desired purchase in accordance with at least one embodiment of the present invention;

FIG. 4 illustrates a graphic user interface displaying code pattern images of payment instruments, recognizable by a merchant system in accordance with at least one embodiment;

FIG. 5 illustrates a graphic user interface for describing an operation for excluding at least one of payment instrument groups and showing an inactivated payment instrument in accordance with at least one embodiment; and

FIG. 6 illustrates a method for providing a service enabling a user to intuitively identify, select, and combine beneficial payment instruments to estimate a lowest payment amount for a desired purchase in accordance with at least one embodiment.

### DESCRIPTION OF EMBODIMENTS

Reference will now be made in detail to embodiments of the present invention, examples of which are illustrated in the accompanying drawings, wherein like reference numerals refer to like elements throughout. The embodiments are described below, in order to explain the present invention by referring to the figures.

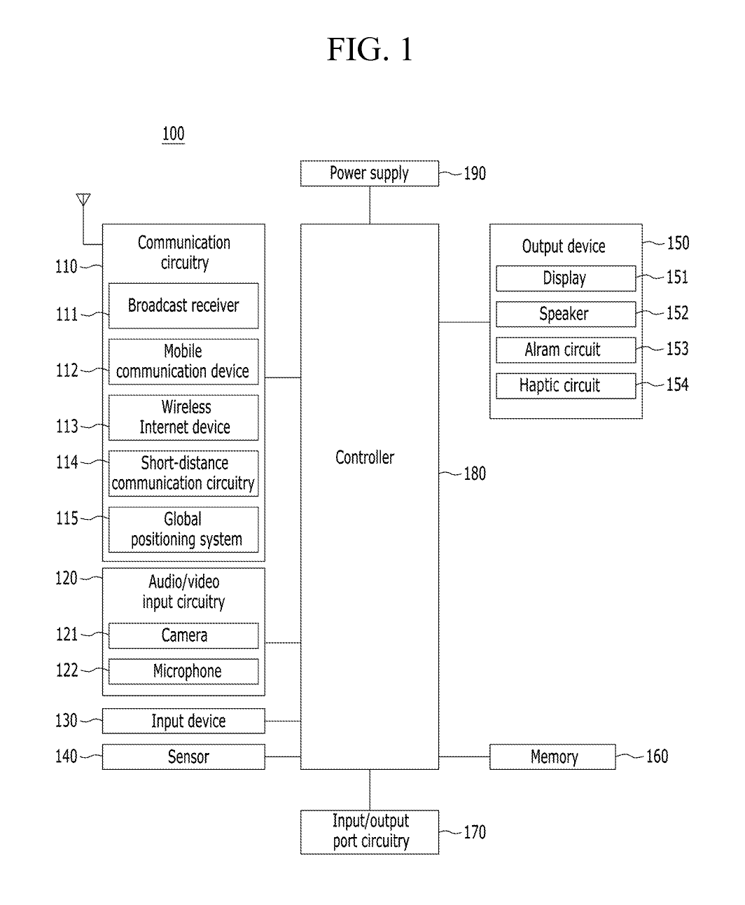

In accordance with at least one embodiment, a consumer is provided with a service for estimating the lowest payment amount for a desired purchase by combining payment instruments based on membership benefits thereof. Particularly, a consumer is provided with a service for selecting payment instruments returning the relatively best membership benefits and for estimating a payment amount for a desired purchase based on combination of the selected payment instruments through minimum user inputs. Such a service is provided through a service application installed and executed in user equipment in association with a related service server. Upon the execution of the service application, user equipment provides a graphic user interface that enables a user to intuitively identify payment instruments associated with a desired purchase, to conveniently select payment instruments returning the relatively best membership benefits among payment instruments associated with a desired purchase or a merchant thereof, and to easily combine the selected payment instruments to find the lowest payment amount for the desired purchase. Particularly, such a graphic user interface i) displays images of payment instruments classified by a payment instrument type, ii) scrollorably displays images of the classified payment instruments, and iii) displays an estimated lowest payment amount for a desired purchase by combining membership benefits of payment instruments based on payment instrument images scrolled and arranged at a selection position thereof. Hereinafter, user equipment providing such a service will be described with a reference to FIG. 1.

FIG. 1 illustrates user equipment in accordance with at least one embodiment of the present invention. Referring to FIG. 1, user equipment 100 may include a communication circuitry 110, an audio/video input circuitry 120, an input device 130, a sensor 140, an output device 150, a memory 160, an input/output port circuitry 170, a controller 180, and a power source 190.

Communication circuitry 110 transmits and receives signals to/from other entities through a communication network based on various types of communication schemes. Communication circuitry 110 may be referred to as a transceiver and include at least one of a mobile communication circuit, a wireless internet circuit, a near field communication (NFC) circuit, a global positioning signal receiving circuit, and so forth. Particularly, communication circuit 110 may include a short distance communication circuit for short distance communication, such as NFC, and a mobile communication circuit for long range communication through a mobile communication network, such as long term evolution (LTE) communication or wireless data communication (e.g., WiFi).

For example, communication circuitry 110 may include at least one device for communicating with other party through a wireless communication system. For example, communication circuitry 110 may include at least one of a broadcast receiver 111, a mobile communication device 112, a wireless Internet device 113, a short-distance communication circuitry 114, and a global positioning system 115. Broadcast receiver 111 may receive a broadcast signal or broadcast related information from a broadcast management server through a broadcast channel. Mobile communication device 112 may transmit and receive a wireless signal to/from at least one of a base station, an external device, or a server. The wireless signal may be various types of data for receiving and transmitting a voice call signal, a video call signal, a text or multimedia message, but is not limited thereto.

Wireless Internet device 113 may be a device for accessing wireless Internet. Wireless Internet device 113 may be placed internally or externally on user equipment 110. Wireless Internet device 113 may employ Wireless LAN (WLAN) (Wi-Fi), Wireless Broadband (Wibro), World Interoperability for Microwave Access (WiMAX), High Speed Downlink Packet Access (HSDPA). Short-distance communication circuitry 114 may be a circuitry for communicating within short-distance. Short-distance communication circuitry 114 may include Bluetooth, Radio Frequency Identification (RFID), Infrared Data Association (IrDA), Ultra Wideband (UWB), ZigBee, Near Field Communication (NFC). Global positioning system 115 may be a device for obtaining information on a location of user equipment 110. Beside global positioning system 115, user equipment 100 may include other devices that detect and obtain information on a location of user equipment 100. Such device may be referred to as location information device 115.

Audio/video input circuitry 120 may receive audio/video input, such as an audio signal and/or a video signal. For example, audio/video input circuitry 120 may include camera 121 for capturing images and microphone 122 for recording sound. Camera 121 may process image frames of a still image or a moving image, which are captured by an image sensor in a video call mode or a photographic mode. The processed image frames may be output through display 151.

Input device 130 may be a user interface for receiving an input from a user. Input device 130 may be realized in various types. For example, input device 130 may be realized as a touch keypad integrated with display 151. Sensor 140 may detect a current status of user equipment 100. For example, sensor 140 may sense an opening or a closing of a cover of user equipment 100, a physical contact with or a proximity to a user, a location and a bearing of user equipment 100, or acceleration and deceleration of user equipment 100. Based on the detected status of user equipment 100, sensor 140 may generate a sensing signal to control the operation of user equipment 100.

Output device 150 may be a device for outputting video, audio, or tactile feedback. Output device 150 may include display 151, speaker 152, alarm circuit 153, and haptic circuit 154, but is not limited thereto.

Display 151 may display information processed on user equipment 100. For example, display 151 may display a call related user interface (UI) or graphic user interface (GUI) while user equipment 100 is in an on-call mode. Display 151 may also display captured or received image frames and/or a related UI or GUI while in a video call mode or a photographic mode. Display 151 may display a graphic user interface for various types of service applications. Display 151 may be a liquid crystal display, a thin film transistor-liquid crystal display, an organic light-emitting diode, a flexible display, or 3D display, but is not limited thereto.

Display 151 may be a touch screen configured to receive inputs and to display information simultaneously. Display 151 may include a touch sensor layered on or beneath display 151. The touch sensor is configured to detect a touch input. The touch sensor may be a touch film, a touch sheet, or a touch pad, but the present invention is not limited thereto. The touch sensor may be configured to convert a pressure applied to or a change in capacitance around a particular place on display 151 into an electric input signal. The touch sensor may detect a pressure, a particular location where a touch input is made, or a direction of a touch input. When the touch sensor detects a touch input, the touch sensor sends a corresponding electric input signal to a touch controller. The touch controller processes the electric input signal and sends a corresponding data to main controller 180. The touch controller determines an area of display 151 where the touch input is made.

User equipment 100 may include a proximity sensor, for example, near to the touch screen. The proximity sensor may detect, without physical contact, an approaching object or presence of an object in a vicinity of user equipment 110 using electromagnetic field or infrared rays. The proximity sensor may have a longer lifespan and more practical uses than a contact sensor. The proximity sensor may include a through-beam photo electric sensor, a reflective photo electric sensor, a mirror-reflective photo electric sensor, a high-frequency oscillation-type proximity sensor, a capacitive proximity sensor, and a magnetic proximity sensor, but the present invention is not limited thereto.

In case of a capacitive touch screen, such a touch screen can detect proximity of an approaching object based on change in electromagnetic filed around user equipment 110. In this case, the touch screen may function as the proximity sensor. Such a proximity sensor detects a proximity touch or a proximity touch pattern. For example, the proximity sensor may detect a distance, speed, time, location, or moving status of a touch. The touch screen displays information processed or generated based on the sensed proximity touch and the sensed proximity touch pattern.

The touch screen may display one or more graphical elements as a user interface. Such a touch screen enables a user to select or to activate an operation associated with at least one of graphic elements displayed thereon. For example, user can select or activate at least one graphical element by touching the one using one or more fingers or by releasing the touched graphical element. The touch screen may detect various types of gesture inputs. The gesture inputs may include a touch input, a tap input, a double tap input, a hold input, a touch and move input, a flick or swipe input, and a drag and drop input. The touch input may initiate operation for selecting a predetermined graphical element or an area around a predetermined graphical element. The tap input may initiate operation for executing an application associate with a predetermined graphical element. The double-tap input may initiate operation for controlling (e.g., enlarging or reducing) a size of a graphical element. The hold input may initiate operation for activating a detail menu associated with a selected graphical element. The touch and move input may initiate operation for scrolling a graphical element. The flick or swipe input may initiate operation for moving in and out of the layers of graphical elements. The drag and drop input initiates operation for moving selected graphical elements.

Speaker 152 may output audio data stored in memory 160 or output audio data received through communication circuitry 110 when receiving a call signal. Alarm circuit 153 may output a signal informing a predetermined event. The predetermined event may include receiving a call, receiving a message, receiving a key input, or receiving a touch input, but the present invention is not limited thereto.

Haptic circuit 153 may generate various tactile feedbacks to a user. For example, haptic circuit 153 may generate vibration. Haptic circuit 153 controls intensity and pattern of vibration according to an event type invoking such vibration. For example, haptic circuit 153 may generate different patterns of vibration simultaneously or in a predetermined order upon the receipt of a call and upon the receipt of a message.

Memory 160 stores various types of data including operating system for controlling user equipment 100 and at least one application necessary for providing a mobile payment service. For example, memory 160 may store software programs for operating user equipment 100. Memory 160 may also store input/output data including a phonebook, a message, a still image, or a video. Memory 160 may store data related to various vibration patterns or sound effects which are outputted in response to user input on touch screen 121. In accordance with at least one embodiment, memory 160 may store at least one application for a mobile payment service and data generated during performing operation associated with the application.

Memory 160 may be a flash memory, a hard disk, a multimedia card micro memory, a SD or XD memory, a Random Access Memory (RAM), a Static Random Access Memory (SRAM), a Read-Only Memory (ROM), a Programmable Read-Only Memory (PROM), an Electrically Erasable Programmable Read-Only Memory (EEPROM), a magnetic memory, a magnetic disk, or an optical disc, but the present invention is not limited thereto.

User equipment 100 may be coupled to an external device through input/output port circuitry 170. Input/output port circuitry 170 may receive data or power from the external device and may deliver data or power to the constituent elements of user equipment 100. Input/output port circuitry 170 may include a wired/wireless headset port, an external power source port, a wired/wireless data port, a memory card port, an audio input/output port, a video input/output port, an earphone port, or any port configured to be coupled to device with identification module.

User equipment 100 may include an identification module such as a user identify module (UIM), a subscriber identity module (SIM), and a universal subscriber identity module (USIM). Such an identification module may be manufactured in a form of a smart card. The identification module may be coupled to user equipment 110 through input/out port circuitry 170. In accordance with at least one embodiment, the identification module may store information on predetermined payment instruments. Input/output port circuitry 170 may be a passage delivering power or various command signals from an external device coupled to user equipment 110.

Controller 180 may be a central processing circuitry that controls constituent elements of user equipment 100 based on inputs received from a user. For example, controller 180 executes a software program and/or an instruction set stored in memory 160 to perform various operations necessary to drive user equipment 110. Power source 190 may supply power to the constituent elements of user equipment 110.

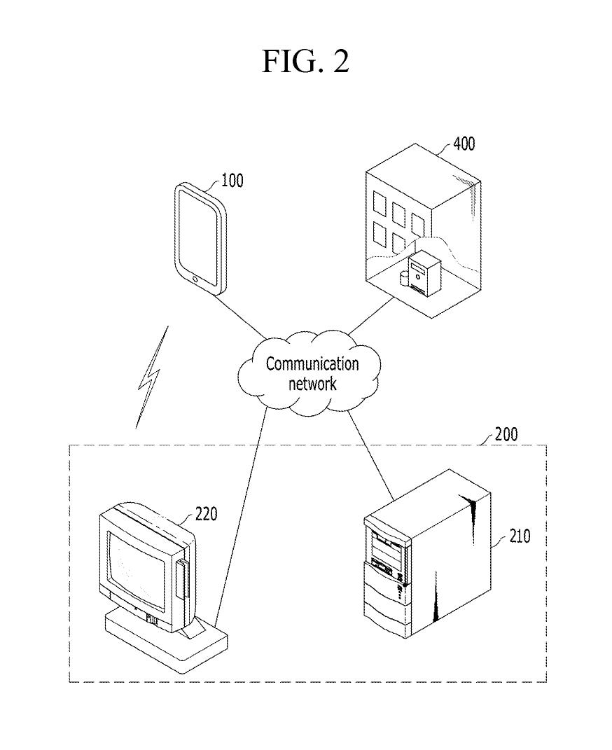

FIG. 2 illustrates a mobile payment service system in accordance with at least one embodiment of the present invention. Referring to FIG. 2, a mobile payment service system includes merchant system 200, user equipment 100, and service server 400. Merchant system 200 includes merchant server 210 and point-of-sale (POS) terminal 120. In the mobile payment service system, a service is provided to a consumer for selecting at least one payment instruments returning the relatively best membership benefits and for estimating the relatively lowest payment of a desired purchase by combining the membership benefits of the selected at least one payment instrument in accordance with at least one embodiment.

As described, merchant system 200 includes merchant server 210 and POS terminal 220. Merchant server 210 stores information on goods or services offered by a merchant and information on payment instruments that return membership benefits to a consumer if the consumer uses the payment instruments to make a payment for goods or services offered by the merchant. The membership benefits may be a discount rate, a bonus point, and a cashback point. The payment instrument may be various types of plastic cards or digitalized cards that can be used by a cardholder and accepted by a merchant to make a payment for a purchase or in payment of some other obligation. Such payment instrument includes a credit card, a debit card, an automated teller machine (ATM) card, a charge card, a stored-value card, a gift card, a membership card, a coupon, and so forth. A payment instrument returning membership benefits may be referred to as a beneficial payment instrument.

Merchant server 210 may provide POS terminal 220 with information necessary for processing a payment request received from user equipment 100 through POS terminal 220. Furthermore, merchant server 210 provides information on beneficial payment instruments to service server 400 and user equipment 100 in response to a request from service server 400 and user equipment 100.

User equipment 100 is an electronic device that provides a consumer with a service for helping the consumer to choose a payment instrument that returns the relatively best membership benefits and to estimate a relatively lowest payment amount for a desired purchase by combining the membership benefits of the selected at least one payment instrument in accordance with at least one embodiment. Such a service is provided through a service application installed and executed in user equipment 100 in connection with service server 400. User equipment 100 may be any device used directly by an end-user to communicate and to perform operations associated with the service. User equipment 100 may include a hand-held telephone, a mobile phone, a smart phone, a personal digital assistance (PDA), a pad-like device, a laptop computer equipped with a mobile broadband adapter, and so forth.

In accordance with at least one embodiment, user equipment 100 receives information on beneficial payment instruments associated with a predetermined merchant or a desired good or service from merchant system 200 or service server 400. Furthermore, user equipment 100 receives information on membership benefits associated with the beneficial payment instruments associated with the predetermined merchant or a desired good or service from merchant system 200 or service server 400.

Based on the received information on the beneficial payment instruments and the membership benefits thereof, user equipment 100 computes combination of beneficial payment instruments to obtain the relatively best membership benefits thereof and provides such computation result to a user through a predetermined graphic user interface of the service application. There are several methods for finding a combination of beneficial payment instruments to obtain the relatively best membership benefits thereof. The present invention is not limited to one specific method.

As described, user equipment 100 provides such a service through a graphic user interface of a service application installed and executed in user equipment 100 in connection with service server 400. Particularly, user equipment 100 may download a relative service application from service server 400 and installed therein. User equipment 100 initiates and executes the service application in response to a user input. As a result thereof, user equipment 100 provides a graphic user interface that enables a user to intuitively identify payment instruments associated with a desired purchase, to conveniently select payment instruments returning the relatively best membership benefits among payment instruments associated with a desired purchase or a merchant thereof, and to easily combine the selected payment instruments to find the lowest payment amount for the desired purchase. The graphic user interface i) displays images of payment instruments classified by a payment instrument type, ii) scrollorably displays images of the classified payment instruments, and iii) displays an estimated lowest payment amount for a desired purchase by combining membership benefits of payment instruments based on payment instrument images scrolled and arranged at a selection position thereof.

Service server 400 is coupled to user equipment 100 and merchant system 200 through various types of communication network configurations. Service server 400 is a server of a company offering the service for helping a consumer to choose a payment instrument that will return the relatively best membership benefits and to estimate a relatively lowest payment amount for a desired purchase by combining the membership benefits of the selected at least one payment instrument in accordance with at least one embodiment.

Service server 400 provides an associated service application to user equipment 100. For example, user equipment 100 downloads the associated service application from service server 400 and installs the downloaded service application for providing such a service to a consumer.

Service server 400 provides various types of information associated with a merchant and a good or service to user equipment 100. For example, service server 400 regularly collects information on beneficial payment instruments from merchant system 200, stores the collected information, and provides the collected information to user equipment 100. Such beneficial payment instrument information may include an image of each beneficial payment instrument and membership benefits associated with each beneficial payment instrument.

Furthermore, service server 400 regularly collects information on promotion events associated with a predetermined merchant from merchant system 200 and provides such promotion event information to user equipment 100. The promotion event information may include information on offered membership benefits (e.g., a discount rate), a condition for receiving such membership benefits, and an event period.

Particularly, service server 400 may i) regularly collect information on beneficial payment instruments from merchant system 200, ii) store and analyze the collected information, iii) calculate priorities of the beneficial payment instruments to select, and iv) provide the result thereof to user equipment 100, but the present invention is not limited thereto.

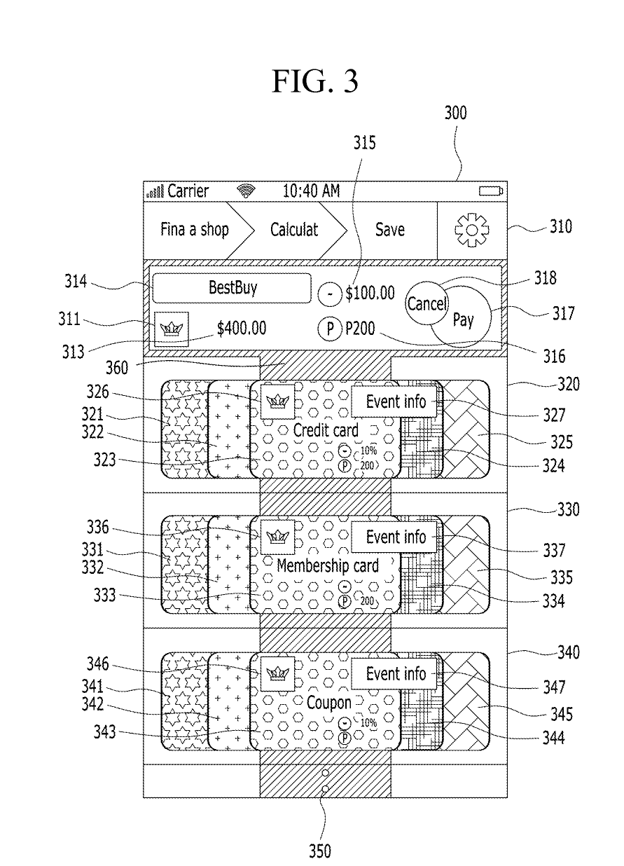

As described, upon the execution of a service application, user equipment 100 provides a graphic user interface that enables a user to intuitively identify, select, and combine payment instruments returning the relatively best membership to find the lowest payment amount for the desired purchase. Such a graphic user interface in accordance with at least one embodiment scrollably displays images of the classified payment instruments and an estimated lowest payment amount for a desired purchase, which is dynamically updated based on combination of payment instruments each scrolled at a certain display position. Hereafter, such a graphic user interface of a service application will be described in detail with reference to FIG. 3

FIG. 3 illustrates a graphic user interface for enabling a user to intuitively identify, select, and combine beneficial payment instruments to estimate a lowest payment amount for a desired purchase in accordance with at least one embodiment of the present invention. The graphic user interface of FIG. 3 may be displayed on user equipment 100 as a result of executing a service application (e.g., App) downloaded from associated service server 400 and installed in user equipment 100. Such a graphic user interface in accordance with at least one embodiment displays beneficial payment instruments and an estimated payment amount thereof within a single page (i.e., the same screen) of a graphic user interface in a way that enables a user i) to intuitively identify beneficial payment instruments associated with a desired purchase, ii) to conveniently select payment instruments returning the relatively best membership benefits among the beneficial payment instruments, and iii) to easily identify an estimated payment amount for the desired purchase, which is dynamically changed according to the selection of payment instruments.

Particularly, the graphic user interface of the service application displays images of payment instruments classified by a payment instrument type, ii) scrollorably displays images of the classified payment instruments, and iii) displays an estimated lowest payment amount for a desired purchase by combining membership benefits of payment instruments based on payment instrument images scrolled and arranged at a selection position thereof.

Referring to FIG. 3, graphic user interface 300 may be a default screen of the service application. Such graphic user interface 300 of may include a plurality of screens each generated and displayed according to an operation performed in response to a user input.

Graphic user interface 300 may show information in a portrait view and have a display area laterally divided by types of information to be shown, but the present invention is not limited thereto. Particularly, graphic user interface 300 includes four display areas: first display area 310, second display area 320, third display area 330, and fourth display area 340. Although the display area of graphic user interface 300 is illustrated as being divided into four display areas, the present invention is not limited thereto. The number or the size of display areas may vary according to embodiments.

Through first display area 310, user equipment 100 displays basic information on a merchant associated with a desired purchase and a payment of the desired purchase. For example, in first display area 310, various types of graphical elements are displayed for showing i) menus for selecting options and functions, ii) interactive icons for receiving predetermined user inputs and initiating an associated operation, and iii) payment information including an estimated payment amount for a desired service or good.

Particularly, first display area 310 displays information on an estimated payment amount based on combination of membership benefits of selected beneficial payment instruments that are arranged at a selection position of each display area. First display area 310 displays estimated payment amount 315 and bonus points 316 associated with membership benefits of the selected beneficial payment instruments that are arranged at a selection position of each display area.

First display area 310 also displays merchant information 314, such as a name of an associated merchant, such as “Best Buy”. First display area 310 includes interactive icons such as cancel icon 318 for cancelling an ongoing payment process and payment icon 319 for initiating a payment process based on selected payment instruments which are arranged at a selection position of each display area.

In addition, first display area 310 includes a menu bar having menus for finding a shop, estimating a lowest payment, and saving combination of selected payment instruments. Furthermore, first display area 310 includes a setting icon for setting user environments of the service application.

Through second display area 320 to fourth display area 340, user equipment 100 displays information on beneficial payment instruments associated with a merchant or a desired good or service in accordance with at least one embodiment. User equipment 100 may receive information on an associated merchant from merchant system 200 upon a predetermined event. Based on the merchant information, user equipment 100 may request information on beneficial payment instruments associated with the merchant to service server 400 and receive the requested information from service server 400. Or, user equipment 100 may directly collect such information on beneficial payment instruments from a related server such as merchant server 210. The requested information may include various types of information, such as a payment instrument type, a payment instrument name, an account number, an expiration data, a security code, associated membership benefits, associated promotion events, an actual image thereof, and so forth. In addition, user equipment 100 may store information on such payment instruments in a memory of user equipment 100 or an identification circuit mounted at user equipment 100. The identification circuit may be an integrated chip or a smart card of a certain payment instrument.

Based on the obtained information on beneficial payment instruments, user equipment 100 classifies beneficial payment instruments by a payment instrument type such as a credit card type, a membership card type, and a coupon type. That is, beneficial payment instruments are classified into a credit card candidate group, a membership card candidate group, and a coupon candidate group, as shown in FIG. 3, but the present invention is not limited thereto. The credit card candidate group includes credit cards that returns membership benefits to a consumer if the consumer uses one of the credit cards to make a payment for the desired purchase. The membership card candidate group includes membership cards that returns membership benefits to a consumer if the consumer uses one of the membership cards to make a payment for the desired purchase. Furthermore, the coupon candidate group includes coupons that returns associated benefits to a consumer if the consumer uses one of the coupons to make a payment for the desired purchase. Although user equipment 100 is described as performing the classification of payment instruments, the present invention is not limited thereto. Service server 400 may perform such classification operation and provide information on classified payment instruments to user equipment 100. In this case, user equipment 100 may display such information in corresponding display areas.

In accordance with at least one embodiment, user equipment 100 displays information on each payment instrument candidate groups in a corresponding display area. For example, user equipment 100 displays information on a credit card candidate group in second display area 320, displays information on a membership card candidate group in third display area 330, and displays information on a coupon card candidate group in fourth display area 340, as shown in FIG. 3.

Particularly, user equipment 100 obtains images of payment instruments in each candidate group from the received beneficial payment instrument information and displays the obtained images in a corresponding display area. Such images are arranged in a lateral direction as shown in FIG. 3. For example, second display area 320 displays images of credit cards 321 to 325 arranged in a lateral direction. Third display area 330 displays images of membership cards 331 to 335 in a lateral direction. Fourth display area 340 displays images of coupons 341 to 345 in a lateral direction.

User equipment 100 scrollably displays images of payment instruments in each one of display areas 320 to 340. For example, images of payment instruments are scrollable in a left to right direction and/or a right to left direction in order to enable a user to navigate one payment instrument to the others. User equipment 100 detects user inputs for scrolling images and scrolls the images in the left to right direction or the right to left direction according to the detected user inputs. For example, a user can scroll images of credit cards 321 to 325 in the left to right direction or the right to left direction by touching a displayed image of a credit card and moving the image in a desired direction to a desired position (e.g., a selection position). For example, images of payment instruments may be displayed in a cover flow manner in each display area.

Through such scrolling operation, a user selects one of payment instruments for making a payment of a desired good or service. For example, a user selects one of payment instruments by scrolling an image of a payment instrument to selection position 360, such as a center position of each display area (e.g., 320 to 340). User equipment 100 detects an image of a payment instrument scrolled and arranged at selection position 360, obtains information on the associated payment instrument, and calculates an estimated payment amount of a desired purchase based on membership benefits associated with the selected payment instrument based on the obtained information.

Except first display area 310, each display area (e.g., 320 to 340) is scrollable by itself independently of the others. For example, images of credit cards 321 to 325 in second display area 320 are scrollable independently from payment instrument images in other display areas 330 and 340. Such graphic user interface 300 enables a user to select one from each payment instrument candidate group independently from others. That is, a user can scroll an image of a desired credit card in display area 220 to selection position 360 independently from images in other display areas 330 and 340. Furthermore, a user can scroll an image of a desired coupon in display area 340 to selection position 360 independently from images in other display areas 320 and 340.

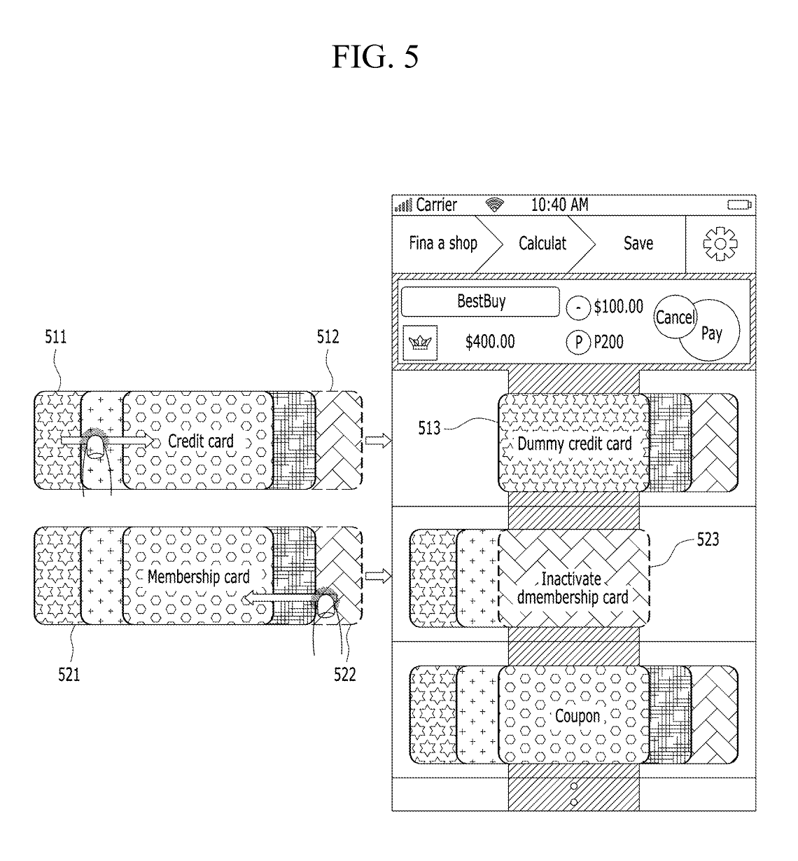

User equipment 100 detects a payment instrument scrolled and arranged at selection position 360 in each display area (e.g., 320 to 340) as a selected payment instrument and calculates an estimated payment amount for a desired purchase by combining membership benefits of each selected payment instrument. As shown in FIG. 5, an image of credit card 323 is arranged at selection position 360 in second display area 320, an image of membership card 333 is arranged at selection position 360 in third display area 330, and an image of coupon 343 is arranged at selection position 360 in fourth display area 340. Such arrangement may be a result of scrolling operation performed in response to a user input. In this case, user equipment 100 combines membership benefits of credit card 323, membership card 333, and coupon 343 and calculates a payment amount based on the combined membership benefits. That is, membership benefits of credit card 323, membership card 333, and coupon 343 may be 10% discount, 200 bonus points, and 10% discount, respectively as shown in FIG. 3. In this case, user equipment 100 applies 20% discount on a prices of a desired purchase and accumulates 200 bonus points. User equipment 100 shows such results in first display area 310, as estimated payment amount 315 and as bonus points 316.

Graphic user interface 300 was illustrated as including display areas for three payment instrument candidate groups such as a credit card candidate group, a membership card candidate group, and a coupon candidate group, but the present invention is not limited thereto. Graphic user interface 300 may include more display areas for other types of candidate groups, a debit card, a store card, or a gift card may be displayed in display areas 310 to 330. In this case, such display areas for other candidate groups may be hided and scrolling icon 350 may be displayed at a bottom of the last display area of a payment instrument candidate group. Upon the activation of scrolling icon 350 (e.g., scrolling operation), user equipment 100 shows hidden display areas by scrolling up display areas 320 to 340. The number and sizes of display areas mapped to payment instruments may be determined in consideration of various factors such as a screen size of a display of user equipment 100.

In accordance with at least one embodiment, user equipment 100 arranges default payment instruments of candidate groups at selection position 360 when the service application is initially activated and graphic user interface 300 is displayed. User equipment 100 calculates an estimated payment amount of a desired purchase based on membership benefits of the default payment instruments. The default payment instrument may be i) a payment instrument that returns the relatively best membership benefits to a consumer among payment instruments of the same group or ii) a payment instrument used lately. The membership benefits may be one of a discount rate, a bonus point, and a cashback point, but the present invention is not limited thereto.

User equipment 100 may collect such information on membership benefits of each payment instrument from a merchant system and select one of payment instruments, which will return the relatively best membership benefits. Alternatively, a service server may collect such information on membership benefits of each payment instrument from a merchant system, select one of payment instruments, which will return the relatively best membership benefits, and provide information on the selected payment instrument to user equipment 100.

As described, through graphic user interface 300, user equipment 100 i) displays information on beneficial payment instruments associated with a predetermined merchant in a single screen of a graphic user interface, ii) displays images of payment instruments classified by a payment instrument type, iii) displays each payment instrument candidate group in a different display area, iv) scrollably displays images of payment instruments in each display area, v) displays payment instrument images in one display area independently scrollable from images in others, and vi) displays an estimated payment amount for a desired purchase which is dynamically changed according to payment instrument images scrolled and arranged at a selection position. Accordingly, graphic user interface 300 enables a user to intuitively identify payment instruments associated with a desired purchase, to conveniently select payment instruments returning the relatively best membership benefits among payment instruments associated with a desired purchase or a merchant thereof, and to easily find the relatively lowest payment amount for a desired purchase based on combination of payment instruments.

Particularly, graphic user interface 300 has certain areas displayed with a specific effect such as highlighting or with a color scheme different from others in order to easily recognize the estimated payment amount and the selected payment instrument. For example, edges of first display area 310 and center positions of second to fourth display areas 320 to 340 may be displayed with highlighting effects or with a color scheme darker than others, as shown in FIG. 3. Such a shape of highlighted areas or darker colored areas of graphic user interface 300 forms a “T” shape. Such a “T” zone graphic user interface in accordance with at least one embodiment enables a user to intuitively identify, select, and combine beneficial payment instruments to estimate a lowest payment amount for a desired purchase.

In accordance with at least one embodiment, whenever user equipment 100 detects such scrolling inputs, user equipment 100 detects payment instruments arranged at selection position 360 of beneficial payment instrument display areas and recalculate an estimated payment amount of a desired purchase based on the detected payment instruments. Such a re-estimated payment amount is displayed through first display area 310. Accordingly, a user can easily recognize changes in the estimated payment amount according to the combination of payment instruments.

Graphic user interface 300 further include icons for automatically computing an optimal combination of payment instruments by selecting payment instruments that return the relatively best membership benefits. The optimal combination of payment instruments denotes payment instrument combination that returns the relatively best membership benefits (e.g., lowest payment amount) to a consumer by combining membership benefits of payment instruments. The relatively lowest payment amount may be estimated based on the optimal combination of payment instruments. Graphic user interface 300 includes first auto selection icon 311 in first display area 310. First auto selection icon 311 initiates an operation for i) automatically selecting a relatively best payment instrument from each payment instrument candidate group, ii) displaying each one of the selected best payment instrument at a corresponding selection position (e.g., the relatively best combination of payment instruments) in each display area, iii) combining membership benefits of the selected payment instruments, iv) calculate the estimated payment amount of a desired purchase, and v) displaying the result of the operation as the estimated payment amount (e.g., 313) in first display area 310.

Furthermore, according to the number of activating (e.g., touching) first auto selection icon 311, user equipment 100 may perform different operations. For example, user equipment 100 may compute a second optimal combination of payment instruments when a user initiates first auto selection icon 311 second time after computing the optimal combination. Particularly, user equipment 100 may perform operation for i) selecting one of payment instrument candidate group, ii) selecting a second best payment instrument from the selected payment instrument candidate group, iii) switching the selected payment instrument with a payment instrument previously displayed at a corresponding selection position, iv) recalculate the estimated payment amount of a desired purchase based on the selected second best payment instrument, and v) displaying the result of the operation as a updated payment amount (e.g., 313) in first display area 310. That is, first auto selection icon 311 initiates operation for selecting one of the payment instrument candidate groups, selecting a second best payment instrument from the selected payment instrument candidate group, arranging and displaying the selected second best payment instrument at a selection position in a first display area associated with the selected payment instrument candidate group, combining a membership benefit of the selected second best payment instrument with membership benefits of payment instruments of other payment instrument candidate groups, arranged at selection positions in first display areas associated with the other payment instrument candidate groups, recalculating the estimated payment amount of the desired purchase based on the combined membership benefits, and displaying the recalculated payment among in the first display area.

Graphic user interface 300 may further include a second auto selection icon (e.g., icons 326, 336, 346) displayed on at least one of images of payment instruments in display areas 320, 330, and 340, as shown in FIG. 3. For example, second auto selection icon 326 is displayed on an image of credit card 323. In this case, second auto selection icon 326 initiates an operation for computing an optimal combination of payment instruments with associated credit card 323. For example, upon the reception of a user input activating second auto selection icon 326 displayed on an image of credit card 323, user equipment 100 computes the optimal combination of credit card 323 with other payment instruments in different payment instrument candidate groups (e.g., a membership card candidate group and a coupon candidate group). In order to compute the optimal combination of credit card 323, user equipment 100 may select a payment instrument associated with membership benefit enhancing membership benefit of credit card 323 from each one of the membership card candidate group and the coupon candidate group. That is, a payment instrument having membership benefit matched with that of credit card 323. Then, user equipment 100 arranges images of the selected payment instruments to be positioned at selection position 360 of display areas 330 and 340. User equipment 100 calculates and displays a corresponding estimated payment amount on first display area 310.

The graphic user interface of the service application includes event info icon (e.g., 327, 337, 347) on an image of associated payment instrument (e.g., 323, 333, 343). Event info icon 373, 337, and 347 initiates operation for displaying information on a promotion event associated with each payment instrument. Upon the activation of event info icon 327, 337, and 347, event info icon 327, 337, and 347 directly shows information on a promotion event thereon or initiates an operation for opening an additional window that shows associated promotion event information. In addition, such event info icon 327, 337, 347 may show information on associated payment instrument. For example, upon the activation of event info icon 327, information on membership benefits (e.g., a discount rate, bonus points, or cashback points) of credit card 323 is displayed on event info icon 327 or an additional window is opened with information on the membership benefits of credit card 323. Such information on membership benefits of each payment instrument may be regularly downloaded from an associated server and stored in a memory of user equipment 100.

As described, graphic user interface 300 includes payment icon 317 and payment cancel 318 in first display area 310. Payment icon 317 initiates an operation for making a payment for a desired purchase based on combination of payment instruments, which are positioned at selection positions 360 of second to fourth display areas 320 to 340. For example, when user equipment 100 detects a user input for activating payment icon 317, user equipment 100 obtains information on payment instruments arranged at selection position 360 of each beneficial payment instrument display area and transmits a payment request with the obtained information to a merchant system such as POS terminal 220. Particularly, such obtained information is transmitted when user equipment 100 is contacted to POS terminal 220 (e.g., tagging operation) when POS terminal 220 supports near field communication (NFC).

Cancel icon 318 initiates an operation for canceling a payment process in progress (e.g., ongoing payment process). For example, when user equipment 100 detects a user input for activating cancel icon 318, user equipment 100 cancels an associated ongoing payment process.

When POS terminal 220 or user equipment 100 do not support NFC, user equipment 100 may convert associated payment instruments into code pattern images that can be recognized by POS terminal 220. Such code pattern images may include a bar code and a quick response (QR) code.

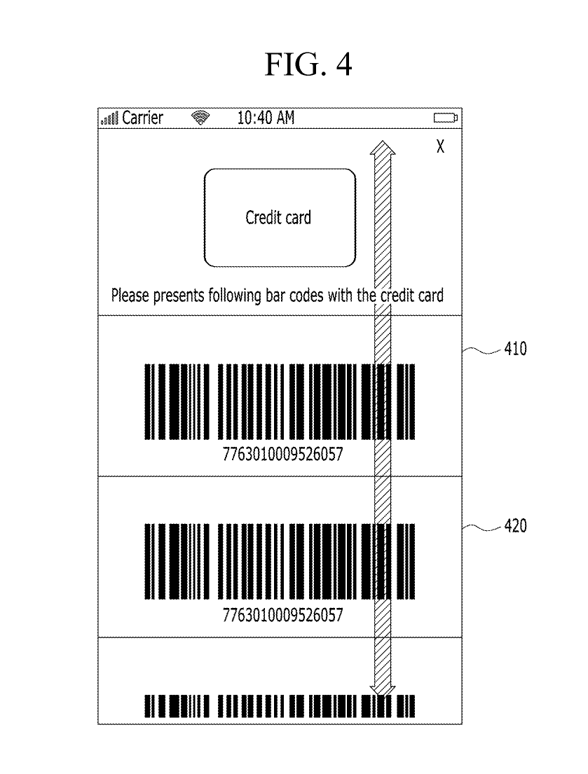

FIG. 4 illustrates a graphic user interface displaying code pattern images of payment instruments, recognizable by a merchant system in accordance with at least one embodiment. As shown in FIG. 4, a membership card or a coupon associated with a predetermined credit card are converted into bar code images 410 and 420 and displayed through another screen. When POS terminal 220 may scan bar code images 410 and 420, membership benefits associated with bar code images 410 and 420 are applied to a payment amount of a desired purchase.

The service application in accordance with at least one embodiment may provide a function for excluding at least one of payment instrument groups from computing an estimated payment amount. The service application may also provide a function for informing an inactivated payment instrument that might reduce a payment amount even more or obtain more bonus points. Hereinafter, such operation will be described with reference to FIG. 5.

FIG. 5 illustrates a graphic user interface for describing an operation for excluding at least one of payment instrument candidate groups and showing an inactivated payment instrument in accordance with at least one embodiment. In order to enable a user to exclude at least one of payment instrument candidate group, dummy payment instrument image 513 is included in each payment instrument candidate group. For example, dummy payment instrument image 513 is arranged with images of payment instruments in each payment instrument candidate group. Dummy payment instrument image 513 may be the first image in each payment instrument candidate group. When a user scrolls dummy payment instrument image 513 at a selection position, user equipment 100 excludes the corresponding payment instrument candidate group from an ongoing payment process.

In order to enable a user to activate an inactivated payment instrument or issue an unissued payment instrument, inactivated payment instrument image 523 is included in a corresponding payment instrument candidate group. For example, inactivated payment instrument image 523 is arranged with images of payment instruments in each payment instrument candidate group. Inactivated payment instrument image 523 may be the last image in a corresponding payment instrument candidate group. When a user scrolls inactivated payment instrument image 523 at a selection position, user equipment 100 initiates an operation for activating or issuing a corresponding inactivated payment instrument. For example, user equipment 100 displays another graphic user interface for performing activation or issuance of the inactivated payment instrument.

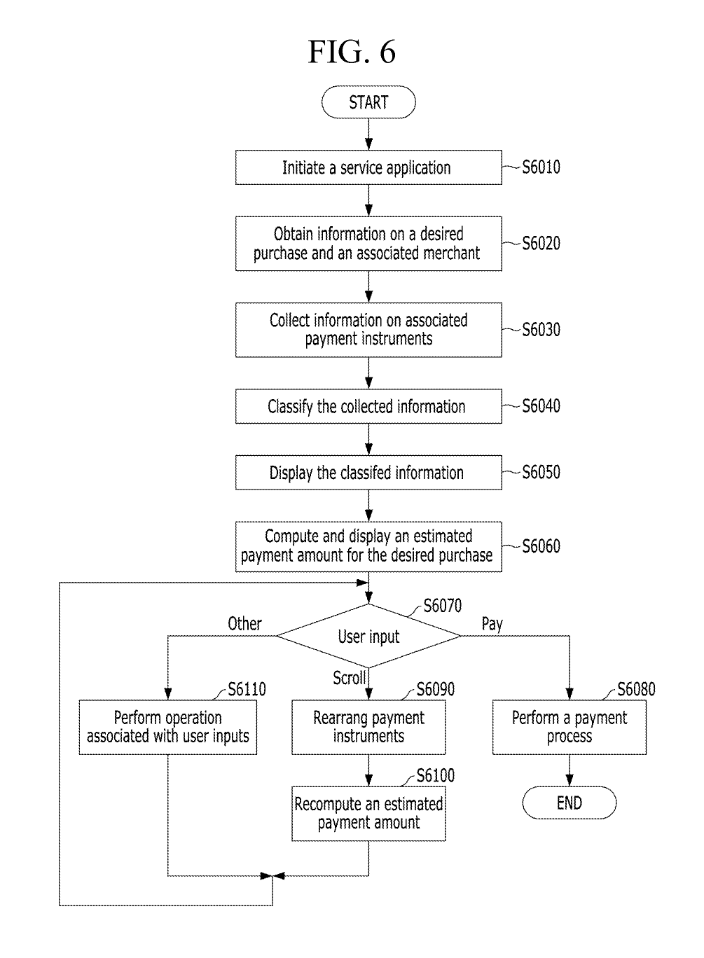

FIG. 6 illustrates a method for providing a service enabling a user to intuitively identify, select, and combine beneficial payment instruments to estimate a lowest payment amount for a desired purchase in accordance with at least one embodiment.

At step S6010, a service application is initiated. For example, an icon of an associated service application may be displayed within a home screen of user equipment 100. When such an icon is activated by a user, user equipment 100 activates the service application for enabling a user to intuitively identify, select, and combine beneficial payment instruments to estimate a relatively lowest payment amount for a desired purchase.

At step S6020, information on a desired purchase and an associated merchant is obtained. For example, user equipment 100 may receive information on a desired purchase and an associated merchant from merchant system 200 including POS terminal 220 upon a predetermined event. The predetermined event may include entering a certain area of a merchant, receiving a predetermined signal from merchant system 200, scanning a good or a service to be purchase with POS terminal 220, and so forth.

At step S6030, information on associated payment instruments is collected. For example, based on the merchant information, user equipment 100 may request information on beneficial payment instruments associated with the merchant to service server 400 and receive the requested information from service server 400. Or, user equipment 100 may directly collect such information on beneficial payment instruments from a related server such as merchant server 210. The requested information may include various types of information, such as a payment instrument type, a payment instrument name, an account number, an expiration data, a security code, associated membership benefits, and so forth.

At step S6040, payment instruments are classified by a payment instrument type. For example, based on the collected information on beneficial payment instruments, user equipment 100 classifies beneficial payment instruments by a payment instrument type such as a credit card type, a membership card type, and a coupon type. That is, beneficial payment instruments are classified into a credit card candidate group, a membership card candidate group, and a coupon candidate group, as shown in FIG. 3, but the present invention is not limited thereto.

At step S6050, a graphic user interface is displayed with information on classified payment instruments. For example, user equipment 100 displays information on each payment instrument candidate groups in a corresponding display area. For example, user equipment 100 displays information on a credit card candidate group in second display area 320, displays information on a membership card candidate group in third display area 330, and displays information on a coupon card candidate group in fourth display area 340, as shown in FIG. 3.

At step S6060, an estimated payment amount for a desired purchase is computed and displayed. For example, user equipment 100 detects a payment instrument arranged at selection position 360 in each display area (e.g., 320 to 340) as a selected payment instrument and calculates an estimated payment amount for a desired purchase by combining membership benefits of each selected payment instrument. Although the steps S6050 and S6060 were described in separated operation steps, the present invention is not limited thereto. The steps S6050 and S6060 are performed simultaneously or the step S6060 is performed prior to the step S6050.

Through steps S6050 and S6060, user equipment 100 produces and displays graphic user interface 300 that i) displays information on beneficial payment instruments associated with a predetermined merchant in a single screen of a graphic user interface, ii) displays images of payment instruments classified by a payment instrument type, iii) displays each payment instrument candidate group in a different display area, iv) scrollably displays images of payment instruments in each display area, v) displays payment instrument images in one display area independently scrollable from images in others, and vi) displays an estimated payment amount for a desired purchase which is dynamically changed according to payment instrument images scrolled and arranged at a selection position. Accordingly, graphic user interface 300 enables a user to intuitively identify payment instruments associated with a desired purchase, to conveniently select payment instruments returning the relatively best membership benefits among payment instruments associated with a desired purchase or a merchant thereof, and to easily find the relatively lowest payment amount for a desired purchase based on combination of payment instruments.

At step S6070, a determination is made to detect a type of a user input when the user input is received. For example, after providing graphic user interface 300, user equipment 100 receives various types of user inputs from a user through graphic user interface 300. Upon the receipt of the user input, user equipment 300 determines a type of the received user input.

When the user input is for activating payment icon 317 (S6070—Pay), a payment process is performed based on payment instruments arranged at selection positions. For example, when a user activates payment icon 317, user equipment 100 performs an operation for making a payment for a desired purchase based on combination of payment instruments, which are positioned at selection positions 360 of second to fourth display areas 320 to 340. For example, when user equipment 100 detects a user input for activating payment icon 317, user equipment 100 obtains information on payment instruments arranged at selection position 360 of each beneficial payment instrument display area and transmits a payment request with the obtained information to a merchant system such as POS terminal 220.

When the user input is for scrolling one of images arranged in a display area (S6070—Scroll), user equipment 100 rearranges corresponding images of payment instruments at step S6080 and recalculates an estimated payment amount of a desired purchase based on payment instruments rearranged at a selection position at step S6090. For example, user equipment 100 detects a scrolling input and rearranges images of payment instruments according to the scrolling input. Furthermore, user equipment 100 detects payment instrument scrolled and arranged at selection position 360 in each display area (e.g., 320 to 340) and calculates an estimated payment amount for a desired purchase by combining membership benefits of each selected payment instrument.

Otherwise (S6070—Other), user equipment 100 performs operation associated with user inputs at S6110. For example, based on a type of the received user input, user equipment 100 may perform operations for cancelling an ongoing payment process, for automatically computing an optimal combination of payment instruments for all candidate groups, for automatically computing an optimal combination of a specific payment instrument with others, for converting payment instruments to code pattern images, for activating an inactivated payment instrument, and so forth. Since such operations were already described with reference to FIG. 3, the detailed description thereof will be omitted herein.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, the terms “system,” “component,” “module,” “interface,”, “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

The present invention can be embodied in the form of methods and apparatuses for practicing those methods. The present invention can also be embodied in the form of program code embodied in tangible media, non-transitory media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits. The present invention can also be embodied in the form of a bitstream or other sequence of signal values electrically or optically transmitted through a medium, stored magnetic-field variations in a magnetic recording medium, etc., generated using a method and/or an apparatus of the present invention.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

As used herein in reference to an element and a standard, the term “compatible” means that the element communicates with other elements in a manner wholly or partially specified by the standard, and would be recognized by other elements as sufficiently capable of communicating with the other elements in the manner specified by the standard. The compatible element does not need to operate internally in a manner specified by the standard.

No claim element herein is to be construed under the provisions of 35 U.S.C. §112, sixth paragraph, unless the element is expressly recited using the phrase “means for” or “step for.”

Although embodiments of the present invention have been described herein, it should be understood that the foregoing embodiments and advantages are merely examples and are not to be construed as limiting the present invention or the scope of the claims. Numerous other modifications and embodiments can be devised by those skilled in the art that will fall within the spirit and scope of the principles of this disclosure, and the present teaching can also be readily applied to other types of apparatuses. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A method for providing a graphic user interface through user equipment for a mobile payment service, the method comprising:
receiving an input for initiating a service application for the mobile payment service;
obtaining information on a desired purchase, an associated merchant, and information on associated payment instruments;
as a result of executing the initiated service application and based on the obtained information, generating a graphic user interface to display i) a plurality of first display areas each assigned to each one of the payment instrument candidate groups, ii) information on payment instruments associated with a corresponding payment instrument candidate group in each first display area, iii) each first display area scrollable independently from other first display areas in response to a user input, iv) scrollable images of payment instruments in each first display area in response to a user input, v) each first display area having a selection position for selecting one of payment instruments of a corresponding payment instrument candidate group, and vi) a second display area including an estimated payment amount for the desired purchase; and
displaying the generated graphic user interface through a display of the user equipment,
wherein the estimated payment amount of the desired purchase is calculated by combining membership benefits of payment instruments arranged at the selection positions of the first display areas.

2. The method of claim 1, comprising:
detecting a scrolling input made by a user through the graphic user interface displayed on the display of the user equipment;
scrolling the images of payment instruments arranged in the first display areas in response to the detected scrolling input;
detecting payment instruments scrolled and arranged at the selection positions of the first display areas;
recalculating the estimated payment amount for the desired purchase by combining membership benefits of the detected payment instruments; and
displaying the recalculated payment amount in the second display area.

3. The method of claim 1, wherein the obtaining comprises:
obtaining information on the desired purchase and the associated merchant from a merchant system;
collecting information on payment instruments associated with the desired purchase and the associated merchant; and
classifying the associated payment instruments into payment instrument candidate groups by a payment instrument type.

4. The method of claim 3, wherein the collecting information comprises:
collecting information on payment instruments from at least one of a memory of the user equipment and an identification chip mounted in the user equipment.

5. The method of claim 1, wherein the generating a graphic user interface comprises:
generating the graphic user interface to display a default payment instrument to be arranged at the selection position of each first display area,
wherein the default payment instrument is a payment instrument returning a relatively best membership benefit to a consumer among payment instruments in the same payment instrument candidate group.

6. The method of claim 1, wherein the generating a graphic user interface comprises:
generating the graphic user interface to display the second display area and more than two of first display areas at a single screen.

7. The method of claim 1, wherein the generating a graphic user interface comprises:
generating the graphic user interface to display the second display area to shows at least one of menus for selecting options and functions associated with the service application, interactive icons for receiving user inputs to initiate an associated operation, and information on the associated merchant, the desired purchase, and associated membership benefits.

8. The method of claim 1, wherein the generating a graphic user interface comprises:
generating the graphic user interface to display a first auto selection icon in the second display area,
wherein in response to a user input selecting the first auto selection icon, the first auto selection icon initiates operations for computing an optimal combination of payment instruments by selecting a relatively best payment instrument from each payment instrument candidate group and calculating an estimated payment amount of the desired purchase based on the computed optimal combination.

9. The method of claim 8, wherein the computing an optimal combination comprises:
selecting a relatively best payment instrument from each payment instrument candidate group;
arranging and displaying the selected best payment instrument at the selection positions of first display areas;
combining membership benefits of the selected payment instruments;
calculating the estimated payment amount of the desired purchase based on the combined membership benefits; and
displaying the calculated payment amount in the second display area.

10. The method of claim 8, wherein the computing an optimal combination comprises:
selecting one of the payment instrument candidate groups;
selecting a second best payment instrument from the selected payment instrument candidate group;
arranging and displaying the selected second best payment instrument at a selection position in a first display area associated with the selected payment instrument candidate group;
combining a membership benefit of the selected second best payment instrument with membership benefits of payment instruments of other payment instrument candidate groups, arranged at selection positions in first display areas associated with the other payment instrument candidate groups;
recalculating the estimated payment amount of the desired purchase based on the combined membership benefits; and
displaying the recalculated payment among in the first display area.

11. The method of claim 1, wherein the generating a graphic user interface comprises:
generating the graphic user interface to display a second auto selection icon on one of images of payment instruments in the first display areas,
wherein in response to a user input selecting the second auto selection icon, the second auto selection icon initiates operations for computing an optimal combination of a payment instrument associated with the second auto selection icon and other payment instruments in different payment instrument candidate groups.

12. The method of claim 11, wherein the computing an optimal combination comprises:
selecting a payment instrument associated with the second auto selection icon;
selecting a relatively best payment instrument from each payment instrument candidate group different from a payment instrument candidate group associated with the second auto selection icon;
arranging and displaying the selected best payment instruments at selection positions in first display areas associated with the payment instrument candidate groups;
combining a membership benefit of the payment instrument associated with the second auto selection icon with membership benefits of the selected best payment instruments;
recalculating the estimated payment amount of the desired purchase based on the combined membership benefits; and
displaying the recalculated payment among in the first display area.

13. The method of claim 1, wherein the generating a graphic user interface comprises:
generating the graphic user interface to display an event info icon on one of images of payment instruments in the first display areas,
wherein in response to a user input selecting the event info icon, the event info icon initiates operations for showing information on a promotion event associated with a payment instrument associated with the event info icon.

14. The method of claim 1, wherein the generating a graphic user interface comprises:
generating the graphic user interface to display a dummy payment instrument image included in at least one of the first display areas,
wherein in response to a user input for selecting and scrolling the dummy payment instrument image to a selection position, a payment instrument candidate group associated with the dummy payment instrument image is excluded from computing the estimated payment amount and a payment process.

15. The method of claim 1, wherein the generating a graphic user interface comprises:
generating the graphic user interface to display an inactivated payment instrument image included in at least one of the first display areas,
wherein in response to a user input for selecting and scrolling the inactivated payment instrument image to a selection position, the method comprising performing operations for issuance of an inactivated payment instrument associated with the inactivated payment instrument image.

16. The method of claim 1, comprising:
converting at least one of payment instruments arranged at the selection positions into predetermined code pattern images; and
displaying the predetermined code pattern images through the display of the user equipment.

17. A non-transitory computer-readable storage medium storing a program for performing an operation on user equipment having a processor, the program which performs a method when executed by the processor, the method comprising:
receiving an input for initiating a service application for the mobile payment service;
obtaining information on a desired purchase, an associated merchant, and information on associated payment instruments; and
as a result of executing the initiated service application and based on the obtained information, generating a graphic user interface to display i) a plurality of first display areas each assigned to each one of the payment instrument candidate groups, ii) information on payment instruments associated with a corresponding payment instrument candidate group in each first display area, iii) each first display area scrollable independently from other first display areas in response to a user input, iv) scrollable images of payment instruments in each first display area in response to a user input, v) each first display area having a selection position for selecting one of payment instruments of a corresponding payment instrument candidate group, and vi) a second display area including an estimated payment amount for the desired purchase;
calculating the estimated payment amount of the desired purchase by combining membership benefits of payment instruments arranged at the selection positions of the first display area; and
displaying the generated graphic user interface through a display of the user equipment.

18. The non-transitory computer-readable storage medium of claim 17, wherein the method comprises:
detecting a scrolling input made by a user through the graphic user interface displayed on the display of the user equipment;
scrolling the images of payment instruments arranged in the first display areas in response to the detected scrolling input;
detecting payment instruments scrolled at the selection positions of the first display areas; recalculating the estimated payment amount for the desired purchase by combining membership benefits of the detected payment instruments; and
displaying the recalculated payment amount in the second display area.

19. A graphic user interface displayed on user equipment as a result of executing a service application for a mobile payment service, the graphic user interface comprises:
a plurality of first display areas respectively assigned to different payment instrument candidate groups;
each first display area displaying information on payment instruments associated with a corresponding payment instrument candidate group;
each first display area scrollable independently from other first display areas in response to a user input;
each first display area displaying scrollable images of payment instruments in response to a user input;
each first display area having a selection position for selecting one of payment instruments of a corresponding payment instrument candidate group; and
a second display area displaying an estimated payment amount for a desired purchase,
wherein the estimated payment amount of the desired purchase is calculated by combining membership benefits of payment instruments arranged at the selection positions of the first display areas.

20. The graphic user interface of claim 19, comprising:
the second display area displaying a first auto selection icon initiating operations for computing an optimal combination of payment instruments by selecting a relatively best payment instrument from each payment instrument candidate group and calculating an estimated payment amount of the desired purchase based on the computed optimal combination;
at least one of the first display areas, displaying a second auto selection icon initiating operations for computing an optimal combination of a payment instrument associated with the second auto selection icon and other payment instruments in different payment instrument candidate groups;
at least one of the first display area, displaying an event info icon initiating operations for showing information on a promotion event associated with a payment instrument related to the event info icon;
at least one of the first display area, displaying an dummy payment instrument image initiating an operation for excluding an associated payment instrument candidate group from computing the estimated payment amount or from a payment process in response to a user input for selecting and scrolling the dummy payment instrument image to a selection position; and
at least one of the first display areas, displaying an inactivated payment instrument image initiating operations for issuance of an inactivated payment instrument associated with the inactivated payment instrument image in response to a user input for selecting and scrolling the inactivated payment instrument image to a selection position.
